(19) United States
(12) Patent Application Publication
(10) Pub. No.: US 2024/0375588 A1
(43) Pub. Date: Nov. 14, 2024

(54) SIDE MIRROR CONTROL DEVICE AND CONTROL METHOD FOR SIDE MIRROR CONTROL DEVICE

(71) Applicant: TOYOTA JIDOSHA KABUSHIKI KAISHA, Toyota-shi Aichi-ken (JP)

(72) Inventor: Udara Eshan MANAWADU, Edogawa-ku Tokyo (JP)

(73) Assignee: TOYOTA JIDOSHA KABUSHIKI KAISHA, Toyota-shi Aichi-ken (JP)

(21) Appl. No.: 18/652,250

(22) Filed: May 1, 2024

(30) Foreign Application Priority Data
May 8, 2023 (JP) 2023-076804

(51) Int. Cl. B60R 1/074; B60R 21/01; B60R 21/013

(52) U.S. Cl. CPC B60R 1/074; B60R 21/013; B60R 2021/01013

(57) ABSTRACT

A side mirror control device for controlling side mirrors of a vehicle includes a mobile object detection unit that detects entry of a mobile object into a side warning area set on left and right sides of the vehicle, and a side mirror control unit that rapidly retracts the side mirror on the side corresponding to the side warning area when the entry of the mobile object into the side warning area is detected when a vehicle speed of the vehicle is lower than a side mirror retraction threshold.

### CROSS-REFERENCE TO RELATED APPLICATIONS

This application is based upon and claims the benefit of priority from Japanese Patent Application No. 2023-076804, filed on May 8, 2023, the entire contents of which are incorporated herein by reference.

### TECHNICAL FIELD

The present disclosure relates to a side mirror control device and a control method for the side mirror control device.

### BACKGROUND

In the related art, Japanese Unexamined Patent Publication No. 11-189097 is known as a technical document regarding a side mirror control device. This publication discloses a device in which a sensor is attached to a side mirror of a vehicle, and the side mirror is retracted when a determination is made that an obstacle will come into contact with the side mirror.

### SUMMARY

However, in a traffic jam or the like, a bicycle or a motorcycle may pass by a side of a vehicle that is stopped or is traveling at low speed. When there is not enough space on the side of the vehicle, such as when a parked vehicle is present on a roadside, there is a risk that the bicycle or motorcycle will collide with the side mirror of the vehicle.

An aspect of the present disclosure is a side mirror control device that controls side mirrors of a vehicle. The side mirror control device includes a mobile object detection unit configured to detect entry of a mobile object into a side warning area set on left and right sides of the vehicle; and a side mirror control unit configured to rapidly retract the side mirror on the side corresponding to the side warning area when the entry of the mobile object into the side warning area is detected when a vehicle speed of the vehicle is lower than a side mirror retraction threshold.

According to the side mirror control device according to an aspect of the present disclosure, since the side mirror on the side corresponding to the side warning area is rapidly retracted when the entry of the mobile object is detected in the side warning area set on the left and right sides of the vehicle, it is possible to curb contact of a mobile object such as a bicycle or motorcycle that enters the side warning area with the side mirror.

In the side mirror control device according to the aspect of the present disclosure, the side mirror control unit may not perform the retraction of the side mirror when a minimum width of a passage space on the side of the vehicle corresponding to the side warning area is equal to or greater than a first threshold even when entry of the mobile object into the side warning area is detected.

In the side mirror control device according to the aspect of the present disclosure, the side mirror control unit may not perform the retraction of the side mirror when a value obtained by subtracting a width of the mobile object from a minimum width of a passage space on the side of the vehicle corresponding to the side warning area is equal to or greater than a second threshold even when entry of the mobile object into the side warning area is detected.

In the side mirror control device according to the aspect of the present disclosure, the side mirror control unit may return the side mirror of the vehicle from a retracted state when the side mirror is retracted due to detection of the entry of the mobile object into the side warning area, and then, the entry of the mobile object into the side warning area has not been detected for a certain period of time.

In the side mirror control device according to the aspect of the present disclosure, the side mirror control unit may return the side mirror of the vehicle from the retracted state when the side mirror is retracted due to detection of the entry of the mobile object into side warning area, and then, the minimum width of the passage space on the side of the vehicle corresponding to the side warning area is equal to or greater than the first threshold due to a change in an environment on the side of the vehicle.

Another aspect of the present disclosure is a control method for a side mirror control device for controlling side mirrors of a vehicle. The control method for a side mirror control device includes detecting entry of a mobile object into a side warning area set on left and right sides of the vehicle; and rapidly retracting the side mirror on the side corresponding to the side warning area when the entry of the mobile object into the side warning area is detected when a vehicle speed of the vehicle is lower than a side mirror retraction threshold.

According to the control method for a side mirror control device according to another aspect of the present disclosure, since the side mirror on the side corresponding to the side warning area is rapidly retracted when the entry of the mobile object is detected in the side warning area set on the left and right sides of the vehicle, it is possible to curb contact of a mobile object such as a bicycle or motorcycle that enters the side warning area with the side mirror.

According to each aspect of the present disclosure, it is possible to curb a mobile object passing by the side of the vehicle coming into contact with the side mirror of the vehicle.

### BRIEF DESCRIPTION OF THE DRAWINGS

FIG. 1 is a block diagram illustrating a side mirror control device according to an embodiment.

FIG. 2 is a plan view illustrating a situation in which a bicycle passes through a gap on the side of a vehicle.

FIG. 3 is a plan view illustrating a side warning area of the vehicle.

FIG. 4 is a plan view illustrating a passage space on the side of the vehicle.

FIG. 5 is a flowchart illustrating an example of rapid side mirror retraction control.

FIG. 6 is a flowchart illustrating a modification example of the rapid side mirror retraction control.

FIG. 7 is a flowchart illustrating an example of side mirror return control.

### DETAILED DESCRIPTION

Hereinafter, embodiments of the present disclosure will be described with reference to the drawings.

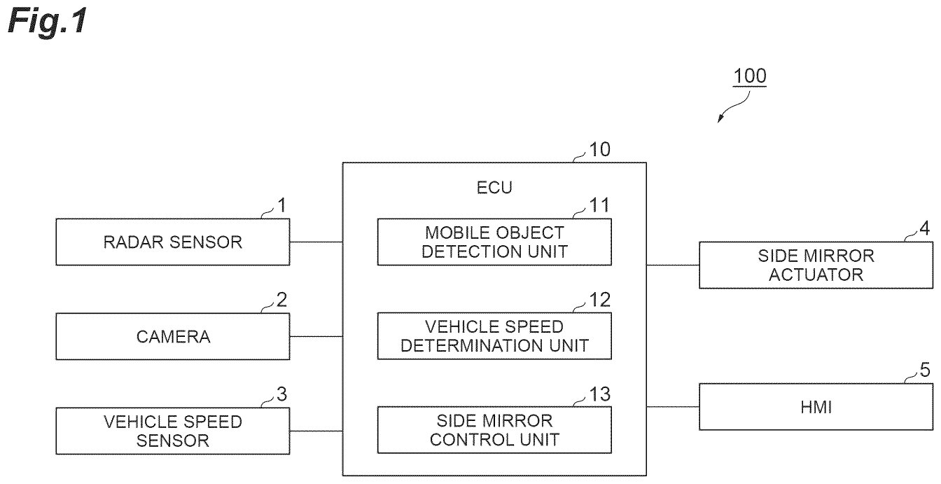

FIG. 1 is a block diagram illustrating a side mirror control device 100 according to an embodiment. The side mirror control device 100 illustrated in FIG. 1 is a device that controls a side mirror of a vehicle. The vehicle may be a passenger car, a cargo vehicle, or an automated driving vehicle. The vehicle is, for example, a four-wheeled vehicle.

Side mirrors are mirrors installed on the left and right sides of a vehicle in order for a driver of the vehicle to check a side to a rear of the vehicle. The side mirrors include a left side mirror provided on the left side of the vehicle and a right side mirror provided on the right side of the vehicle. The side mirrors in the present embodiment are configured to be electrically retractable by a side mirror actuator, which will be described below. Retracting the side mirrors means that the side mirrors protruding to the sides of the vehicle are folded toward a vehicle body.

The side mirror control device 100 copes with a case in which a mobile object such as a bicycle tries to slip through a gap on the side of the vehicle. In this case, the side mirror control device 100 curbs contact between the side mirror and the mobile object by rapidly retracting the side mirror of the vehicle. The mobile object may be a two-wheeled vehicle such as a motorcycle, a personal mobility, or a pedestrian. The personal mobility includes at least one of an electric kick scooter, a two-wheeled free-standing electric mobility, an electric unicycle, an electric skateboard, an electric roller skate, an electric wheelchair, and the like. The pedestrian may include a person moving using a kick scooter, a roller skate, a skateboard, and the like.

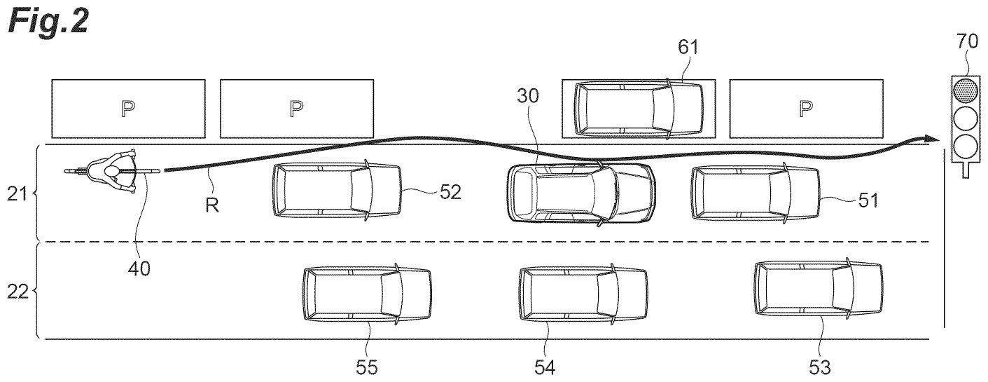

FIG. 2 is a plan view illustrating a situation in which a bicycle passes through a gap on the side of a vehicle. FIG. 2 illustrates a vehicle 30 (own vehicle), a traveling lane 21 in which the vehicle 30 is traveling, an adjacent lane 22 adjacent to the right side of the traveling lane 21, a bicycle 40 approaching from behind the vehicle 30 on the traveling lane 21, and a route R of the bicycle 40. Also, FIG. 2 illustrates a preceding vehicle 51 of the vehicle 30, a following vehicle 52 of the vehicle 30, other vehicles 53 to 55 stopped on the adjacent lane 22, a parked vehicle 61 parked in a parking space on the left side of the traveling lane 21, and a traffic light 70.

In FIG. 2, all the vehicles on the traveling lane 21 and the adjacent lane 22 are stopped because the traffic light 70 is showing red (a lit state in which traffic is prohibited). The bicycle 40 passes to slip through between the stopped vehicle 30 and the parked vehicle 61, as shown as the route R. The side mirror control device 100 according to the present embodiment rapidly retracts the side mirror of the vehicle 30 when a predetermined condition is satisfied due to the presence of the bicycle 40 as illustrated in FIG. 2, thereby curbing the bicycle 40 coming into contact with the side mirror of the vehicle 30.

### [Configuration of Side Mirror Control Device]

Hereinafter, a configuration of the side mirror control device 100 according to the present embodiment will be described. As illustrated in FIG. 1, the side mirror control device 100 includes an electronic control unit (ECU) 10 that collectively manages the system. The ECU 10 may include a plurality of electronic units. A portion of the ECU that performs various controls of the vehicle 30 may be configured to function as the side mirror control device 100, rather than having the side mirror control device 100 include the ECU 10. Here, for ease of understanding, a case in which the side mirror control device 100 includes the ECU 10 will be described.

The ECU 10 is an electronic control unit including a central processing unit (CPU), and a storage unit such as a read only memory (ROM) or a random access memory (RAM). The ECU 10 realizes various functions, for example, by executing programs stored in the storage unit using the CPU.

The ECU 10 is connected to a radar sensor 1, a camera 2, a vehicle speed sensor 3, a side mirror actuator 4, and a human machine interface (HMI) 5.

The radar sensor 1 is a detection device that detects objects around the vehicle 30 using radio waves (for example, millimeter waves) or light. The radar sensor 1 includes a millimeter wave radar and/or a light detection and ranging (LIDAR). The radar sensor 1 detects an object by transmitting radio waves or light to around the vehicle 30 and receiving radio waves or light reflected by the object. The radar sensor 1 transmits information on the detected object to the ECU 10.

The camera 2 is an imaging device that images an external situation of the vehicle 30. The camera 2 is provided at front and rear sides of the vehicle 30 and images the front and rear sides of the vehicle 30. The camera 2 may include a side camera that images to the side of the vehicle 30. The camera 2 transmits imaging information regarding the external situation of the vehicle 30 to the ECU 10. The camera 2 may be a monocular camera or a stereo camera.

The vehicle speed sensor 3 is a detector that detects a vehicle speed of the vehicle 30. As the vehicle speed sensor 3, for example, a wheel speed sensor which is provided on a wheel of the vehicle 30, a drive shaft rotating integrally with the wheel, or the like and detects a rotational speed of the wheel is used. The vehicle speed sensor 3 transmits detected vehicle speed information (wheel speed information) to the ECU 10.

The side mirror actuator 4 is a device for driving the side mirrors of the vehicle 30. As the side mirror actuator 4, for example, an electric motor can be used. The side mirror actuator 4 performs retraction and position adjustment of the side mirror in response to a control signal from the ECU 10.

The HMI 5 is an interface for performing input and output of information between the ECU 10 and the driver. The HMI 5 includes, for example, a display, a speaker, and the like provided in the vehicle cabin. The HMI 5 performs image output from the display and audio output from the speaker in response to a control signal from the ECU 10. The display may be a multi information display (MID) or a head up display (HUD). The HMI 5 may include various indicators.

Next, a functional configuration of the ECU 10 will be described. The ECU 10 includes a mobile object detection unit 11, a vehicle speed determination unit 12, and a side mirror control unit 13.

The mobile object detection unit 11 detects entry of a mobile object into the side warning area set on the left and right sides of the vehicle 30. The mobile object detection unit 11 detects the mobile object on the basis of at least one of a detection result of the radar sensor 1 and the imaging information of the camera 2.

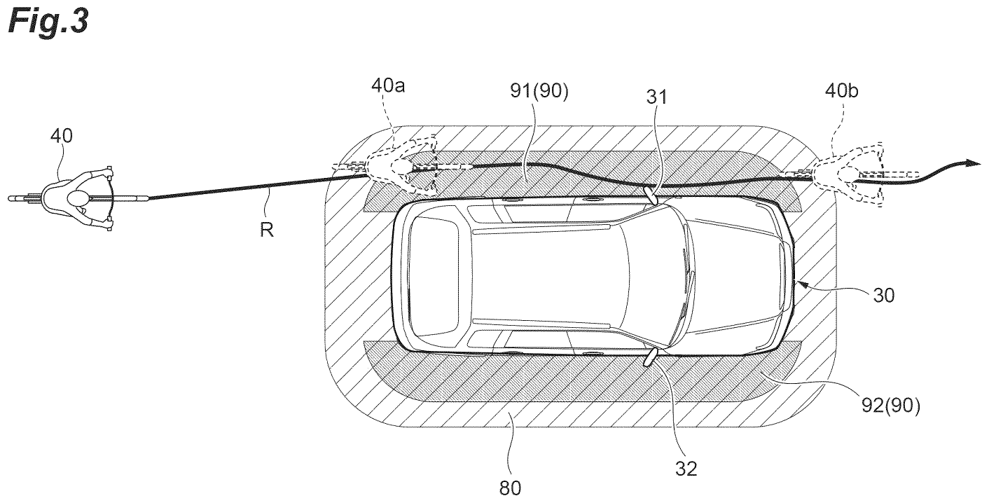

Here, FIG. 3 is a plan view illustrating a side warning area of the vehicle 30. FIG. 3 illustrates a surroundings warning area 80 and a side warning area 90. Further, FIG. 3 illustrates a left side mirror 31 and a right side mirror 32 of the vehicle 30.

The surroundings warning area 80 illustrated in FIG. 3 is an area set to surround the surroundings of the vehicle 30. The surroundings warning area 80 is set to include, for example, a range from an outer edge of the vehicle 30 to a predetermined distance in plan view. This surroundings warning area 80 includes the side warning area 90. The surroundings warning area 80 does not necessarily have to be set.

The side warning area 90 is an area set to detect a mobile object likely to come into contact with the side mirrors of the vehicle 30. The side warning area 90 can be referred to as a rapid retract zone (RRZ) for determining whether rapid retraction of the side mirror is required. The side warning area 90 is an area set on each of the left and right sides of the vehicle 30. The side warning area 90 is set to detect the mobile object likely to come into contact with the side mirror (the left side mirror 31 and the right side mirror 32) of the vehicle 30.

As illustrated in FIG. 3, the side warning area 90 includes a left warning area 91 and a right warning area 92. The left warning area 91 is an area set on the left side of the vehicle 30. The left warning area 91 is set, for example, as an area having a predetermined width from the left side surface of a vehicle body of the vehicle 30 in plan view. A width of the left warning area 91 is set to be larger than the maximum amount of protrusion of the left side mirror 31 from the vehicle body (for example, the width of the left side mirror 31).

Further, the left warning area 91 illustrated in FIG. 3 is set so that a length in a longitudinal direction of the vehicle 30 is longer than an overall length of the vehicle 30. The length of the left warning area 91 is set so that the left warning area 91 protrudes to the rear side of the vehicle 30 compared to the front side of the vehicle 30. A front end of the left warning area 91 is set so that an outer edge draws an arc according to a corner of a left front end of the vehicle 30. The same applies to a rear end of the left warning area 91.

The right warning area 92 is an area set on the right side of the vehicle 30. A shape of the right warning area 92 is the same as a shape obtained by moving the left warning area 91 in a line-symmetrical manner with reference to a longitudinal axis of the vehicle 30 in plan view. Therefore, a description of the shape of the right warning area 92 will be omitted. The shape of the side warning area 90 is not limited to the shape described above.

In a situation illustrated in FIG. 3, the bicycle 40 approaches the stopped vehicle 30 from behind. The bicycle 40 enters the surroundings warning area 80 and the left warning area 91, passes near the left side mirror 31, and passes in front of the vehicle 30. In FIG. 3, a position of the bicycle 40 when the bicycle 40 enters the left warning area 91 is indicated by reference sign 40a. Further, the position of the bicycle 40 when the bicycle 40 passes through the left warning area 91 is indicated by reference sign 40b. The mobile object detection unit 11 detects that the bicycle 40, which has reached the position 40a in FIG. 3, is entering the left warning area 91.

When the bicycle 40 in FIG. 3 enters the surroundings warning area 80, the mobile object detection unit 11 may recognize the bicycle 40 as a monitoring target. The mobile object detection unit 11 may be configured to detect whether or not the bicycle 40 recognized as the monitoring target enters the side warning area 90.

The vehicle speed determination unit 12 determines whether the vehicle speed of the vehicle 30 is lower than a side mirror retraction threshold on the basis of the vehicle speed information detected by the vehicle speed sensor 3. The side mirror retraction threshold is a threshold having a preset value. The side mirror retraction threshold is not particularly limited as long as the value is a value of the vehicle speed at which it is considered that the need for the driver to check the side mirrors is sufficiently low. The side mirror retraction threshold may be 2 km/h, 3 km/h, 5 km/h, 7 km/h, or 10 km/h.

The side mirror retraction threshold may be set to a larger value when the vehicle 30 is in automatic driving than that when the vehicle 30 is in manual driving. When the automatic driving is being executed, it can be considered that the need for the driver to check the surroundings is lower as compared to a case of the manual driving. The automatic driving is vehicle control in which the vehicle 30 is caused to automatically travel along a preset target route. In the automatic driving, the driver does not need to perform any driving operations, and the vehicle 30 automatically travels. The manual driving is a state in which the vehicle 30 travels according to a driving operation of the driver. The manual driving also includes cases where driving assistance control is being executed.

After the side mirrors of the vehicle 30 are retracted, the vehicle speed determination unit 12 determines whether the vehicle speed of the vehicle 30 has become equal to or higher than a side mirror return threshold. The side mirror return threshold is a threshold having a preset value. The side mirror return threshold is not particularly limited as long as the value represents a vehicle speed at which returning the side mirror from the retracted state is considered desirable. The side mirror return threshold may be 2 km/h, 3 km/h, 5 km/h, 7 km/h, or 10 km/h. The side mirror return threshold may have the same value as the side mirror retraction threshold.

The side mirror control unit 13 executes rapid retraction control to rapidly retract the side mirror of the vehicle 30 on the basis of a detection result of the mobile object detection unit 11 and a determination result of the vehicle speed determination unit 12. The side mirror control unit 13 rapidly retracts the side mirror by transmitting a control signal to the side mirror actuator 4. The rapid retraction means that the retraction of the side mirror starts automatically without any operation of the driver. In the rapid retraction, for example, the side mirror comes to the retracted state in a shorter time than in normal retraction. Retraction speeds of the rapid retraction and the normal retraction may be the same.

The side mirror control unit 13 may transmit a control signal to the HMI 5 to notify the driver of the execution of the rapid retraction of the side mirror. The HMI 5 notifies the driver of the execution of the rapid retraction of the side mirror, for example, by an audio output from the speaker. The HMI 5 may perform an image display of the display or a blinking display using the indicator. The side mirror control unit 13 may cause a hazard lamp of the vehicle 30 to blink. The side mirror control unit 13 can alert a mobile object approaching the vehicle 30 by performing blinking of the hazard lamp for two seconds, for example.

Specifically, the side mirror control unit 13 rapidly retracts the side mirror on the side where the mobile object has entered, either the left warning area 91 or the right warning area 92, when the vehicle speed determination unit 12 determines that the vehicle speed of the vehicle 30 is lower than the side mirror retraction threshold and the mobile object detection unit 11 detects the entry of the mobile object into the side warning area 90. The side mirror control unit 13 executes rapid retraction of both the left side mirror 31 and the right side mirror 32 when mobile objects enter both the left warning area 91 and the right warning area 92 when the vehicle speed is determined to be lower than the side mirror retraction threshold. This makes it possible to curb contact between the mobile object and the side mirror of the vehicle 30.

The side mirror control unit 13 may also determine whether or not the rapid retraction control of the side mirror is required on the basis of a surrounding environment of the vehicle 30. The side mirror control unit 13 does not retract the side mirror when the minimum width of the passage space on the side of the vehicle corresponding to the side warning area 90 is equal to or greater than a first threshold even when the entry of the mobile object into the side warning area 90 is detected, for example, when the vehicle speed is lower than the side mirror retraction threshold.

The side mirror control unit 13 calculates the minimum width of the passage space on the side of the vehicle on the basis of at least one of the detection result of the radar sensor 1 and the imaging information of the camera 2. The side mirror control unit 13, for example, uses the radar sensor 1 to detect a structure or an obstacle such as another vehicle on the road edge on the side of the vehicle, and recognizes the shortest lateral distance from the vehicle 30 to the structure or the obstacle on the road edge as the minimum width. The structure of the road edge includes a curb, guardrail, fence, wall, or the like. The side mirror control unit 13 may recognize, as the minimum width, a value obtained by subtracting the amount of protrusion of the side mirror of the vehicle 30 from the shortest lateral distance among the lateral distances from the vehicle 30 to the structure or the obstacle on the road edge.

The first threshold is a threshold having a preset value. The first threshold can be set, for example, as a value of a width that allows a two-wheeled vehicle such as a bicycle or a motorcycle to pass with a margin. The first threshold may be set at 1 m, 1.2 m, or 1.5 m. The first threshold may be a larger value when the vehicle 30 is in automatic driving than when the vehicle 30 is in manual driving.

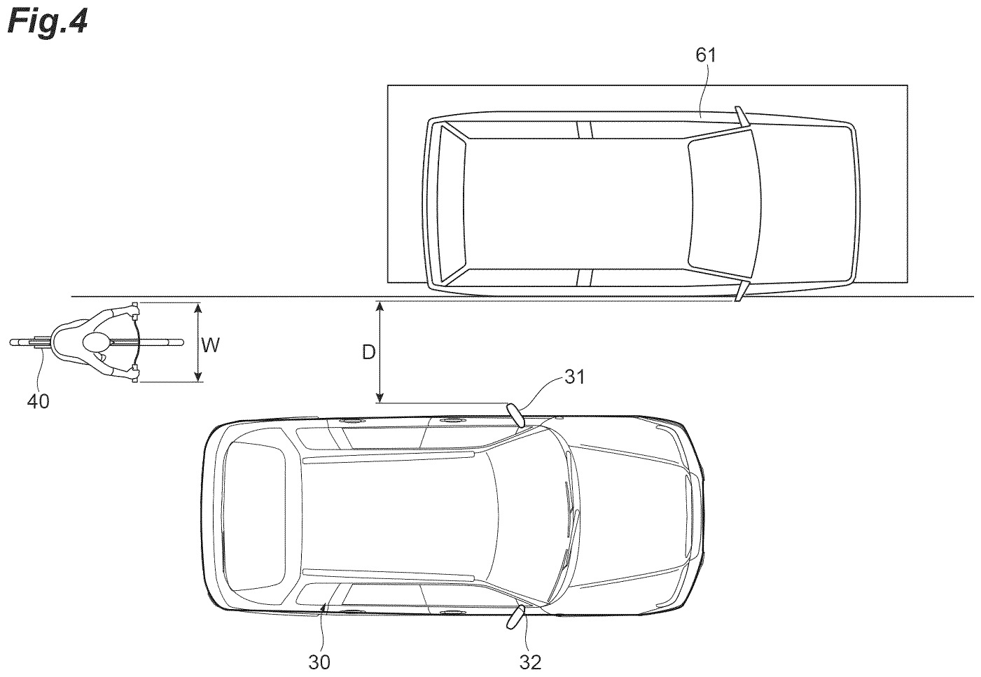

Here, FIG. 4 is a plan view illustrating the passage space on the side of the vehicle. FIG. 4 illustrates a minimum width D of the passage space on the left side of the vehicle 30 and a width W of the bicycle 40. In FIG. 4, entry of the bicycle 40 into the left warning area 91 on the left side of the vehicle 30 is detected. The passage space is a space through which the mobile object can pass on the side of the vehicle 30. In FIG. 4, a space between the vehicle 30 and the parked vehicle 61 is the passage space. The minimum width D of the passage space on the left side of the vehicle 30 is a distance having a smallest width in the passage space. In FIG. 4, the minimum width D corresponds to a distance between the left side mirror 31 of the vehicle 30 and the right side mirror of the parked vehicle 61.

In a situation illustrated in FIG. 4, for example, even when the entry of the bicycle 40 into the left warning area 91 is detected, the side mirror control unit 13 does not retract the left side mirror 31 when the minimum width D of the passage space on the side of the vehicle 30 corresponding to the left warning area 91 in which the entry of the bicycle 40 has been detected is equal to or greater than the first threshold. This makes it possible to avoid retraction of the side mirror which is less required, when a mobile object such as a bicycle affords to avoid contact with the side mirror.

The side mirror control unit 13 may determine whether or not the rapid retraction control of the side mirror is required on the basis of the width W of the mobile object. The side mirror control unit 13 does not perform the retraction of the side mirror when a value obtained by subtracting the width of the mobile object from the minimum width D of the passage space on the side of the vehicle corresponding to the side warning area 90 is equal to or greater than a second threshold even when the entry of the mobile object into the side warning area 90 is detected, for example, when the vehicle speed is lower than the side mirror retraction threshold. The value obtained by subtracting the width of the mobile object from the minimum width D of the passage space on the side of the vehicle corresponds to a value obtained by subtracting the width W of the bicycle 40 from the minimum width D of the passage space on the side of the vehicle 30 in FIG. 4.

The second threshold is a threshold having a preset value. The second threshold can be set as a margin that allows a two-wheeled vehicle such as a bicycle or a motorcycle to maintain an appropriate distance from the side mirror. The second threshold may be 15 cm, 20 cm, or 30 cm. The second threshold may be a larger value when the vehicle 30 is in automatic driving than when the vehicle 30 is in manual driving.

In a situation illustrated in FIG. 4, for example, even when the entry of the bicycle 40 into the left warning area 91 is detected, the side mirror control unit 13 does not perform the retraction of the left side mirror 31 when the value obtained by subtracting the width W of the bicycle 40 from the minimum width D of the passage space on the side of the vehicle 30 corresponding to the left warning area 91 in which the entry of the bicycle 40 has been detected is equal to or greater than the second threshold. The same can be applied to the rapid retraction control of the right side mirror 32 of the vehicle 30.

Next, the return control after the side mirror retraction will be described. The side mirror control unit 13 retracts the side mirror due to the entry of the mobile object into the side warning area 90, and then, returns the position of the retracted side mirror when the vehicle speed determination unit 12 determines that the vehicle speed of the vehicle 30 has become equal to or higher than the side mirror return threshold.

The side mirror control unit 13 transmits a control signal to the side mirror actuator 4 to return the position of the side mirror. The side mirror control unit 13 may transmit a control signal to the HMI 5 to notify the driver of the return of the position of the side mirror. The HMI 5 notifies the driver of the return of the position of the side mirrors, for example, by an audio output from the speaker. The HMI 5 may perform an image display on the display or a blinking display using the indicator. This makes it possible to return the side mirror from the retracted state when the vehicle speed of the vehicle 30 is equal to or higher than the side mirror return threshold and the driver uses the side mirrors to check the surroundings. The side mirror control unit 13 may return the side mirror to a position before retraction or may return the side mirror to a preset setting position.

Further, the side mirror control unit 13 may return the side mirror of the vehicle 30 from the retracted state when entry of the mobile object into the side warning area 90 has not been detected for a certain period of time on the side in which the side mirror has been retracted after the side mirror has been retracted. This makes it possible to automatically return the side mirror when the entry of the mobile object has not been detected for the certain period of time. The certain period of time is not particularly limited. The certain period of time may be 30 seconds, 45 seconds, 1 minute, 2 minutes, or 3 minutes. The certain period of time may be a longer period of time when the vehicle 30 is in automatic driving than when the vehicle 30 is in manual driving.

If the side mirror is retracted on condition that the minimum width D of the passage space on the side of the vehicle is smaller than the first threshold, the side mirror control unit 13 may return the side mirror of the vehicle when the minimum width D becomes equal to or greater than the first threshold due to a change in an environment on the side of the vehicle. The change in an environment on the side of the vehicle is, for example, a case in which the parked vehicle 61 in FIG. 4 moves and the space on the side of the vehicle 30 becomes vacant. The change in an environment on the side of the vehicle also includes a case in which the space on the side of the vehicle 30 becomes vacant due to a forward movement of the other vehicles 53 to 55 in the adjacent lane 22 that have stopped due to a red light of a traffic light. This makes it possible to automatically return the side mirror from the retracted state when the passage space expands due to the change in an environment on the side of the vehicle and the mobile object is less likely to come into contact with the side mirror even when the mobile object enters the space.

### [Control Method for Side Mirror Control Device]

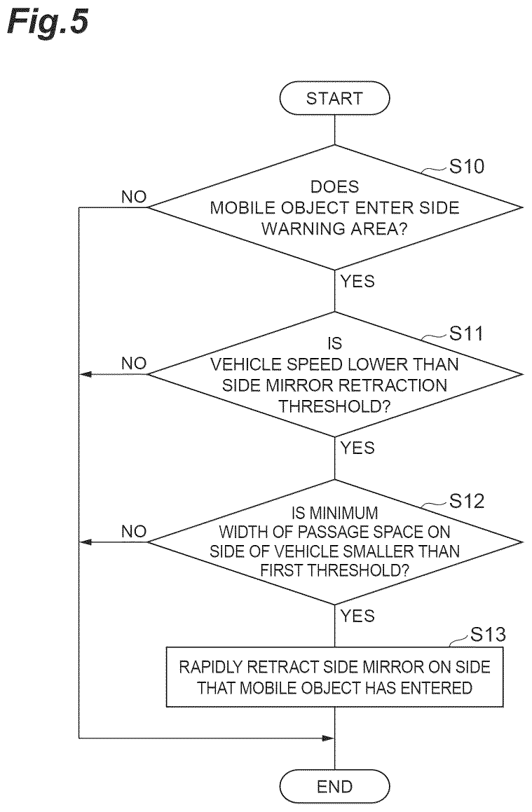

Next, a control method for the side mirror control device 100 according to the present embodiment will be described with reference to the drawings. FIG. 5 is a flowchart illustrating an example of rapid side mirror retraction control. The rapid side mirror retraction control is executed, for example, when an engine of the vehicle 30 is started. The rapid side mirror retraction control may be executed independently for the left side mirror 31 and the right side mirror 32.

As illustrated in FIG. 5, in S10, the ECU 10 of the side mirror control device 100 detects the entry of the mobile object into the side warning area 90 of the vehicle 30 using the mobile object detection unit 11. When the entry of the mobile object into the side warning area 90 is detected (S10: YES), the ECU 10 proceeds to S11. When the entry of the mobile object into the side warning area 90 is not detected (S10: NO), the ECU 10 ends the rapid side mirror retraction control. Thereafter, the ECU 10 repeats the processing from S10 again after a certain period of time.

In S11, the ECU 10 uses the vehicle speed determination unit 12 to determine whether the vehicle speed of the vehicle 30 is lower than the side mirror retraction threshold. When the ECU 10 determines that the vehicle speed is lower than the side mirror retraction threshold (S11: YES), the ECU 10 proceeds to S12. When the ECU 10 does not determine that the vehicle speed is lower than the side mirror retraction threshold (S11: NO), the ECU 10 ends the rapid side mirror retraction control. Thereafter, the ECU 10 repeats the processing from S10 again after a certain period of time.

In S12, the ECU 10 uses the side mirror control unit 13 to determine whether the minimum width D of the passage space on the side of the vehicle on the side that the mobile object has entered is smaller than the first threshold. When the ECU 10 determines that the minimum width D is smaller than the first threshold (S12: YES), the ECU 10 proceeds to S13. When the ECU 10 does not determine that the minimum width D is smaller than the first threshold (S12: NO), the ECU 10 ends the rapid side mirror retraction control. Thereafter, the ECU 10 repeats the processing from S10 again after a certain period of time. The fact that the minimum width D is not smaller than the first threshold means that the minimum width D is equal to or greater than the first threshold.

In S13, the ECU 10 uses the side mirror control unit 13 to execute rapid retraction of the side mirror on the side that the mobile object has entered. The side mirror control unit 13 rapidly retracts the side mirror by transmitting a control signal to the side mirror actuator 4. The side mirror control unit 13 transmits a control signal to the HMI 5 to notify the driver of the execution of the rapid retraction of the side mirror using voice. The side mirror control unit 13 may cause the hazard lamp of the vehicle 30 to blink. Thereafter, the ECU 10 ends the rapid side mirror retraction control.

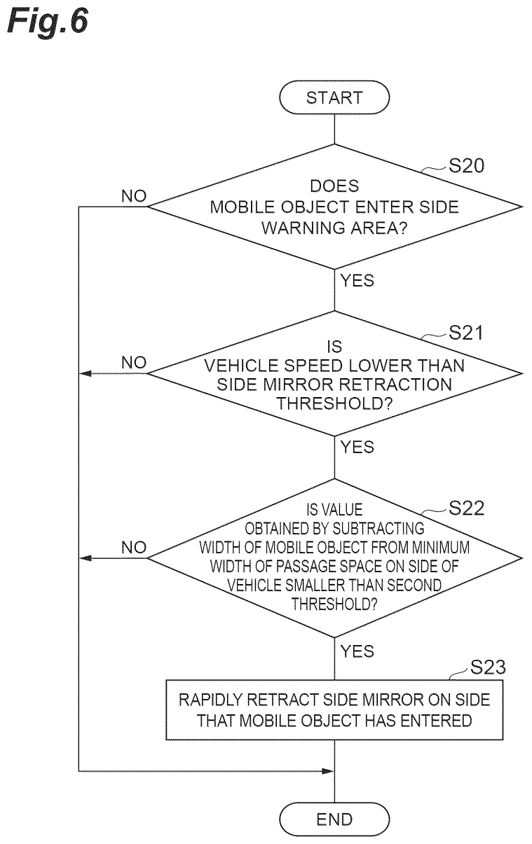

FIG. 6 is a flowchart illustrating a modification example of the rapid side mirror retraction control. The flowchart in FIG. 6 differs from the flowchart in FIG. 5 only in the processing of S22. Since S20 and S21 in FIG. 6 are the same as the processing of S10 and S11 in FIG. 5, description will be omitted.

As illustrated in FIG. 6, in S22, the ECU 10 of the side mirror control device 100 uses the side mirror control unit 13 to determine whether the value obtained by subtracting the width W of the mobile object from the minimum width D of the passage possibility space on the side that the mobile object has entered is smaller than the second threshold.

When the ECU 10 determines that the value obtained by subtracting the width W of the mobile object from the minimum width D is smaller than the second threshold (S22: YES), the ECU 10 proceeds to S23. When the ECU 10 does not determine that the value obtained by subtracting the width W of the mobile object from the minimum width D is smaller than the second threshold (S22: NO), the ECU 10 ends the rapid side mirror retraction control. Thereafter, the ECU 10 repeats the processing from S10 again after a certain period of time. The fact that the value obtained by subtracting the width W of the mobile object from the minimum width D is not smaller than the second threshold means that the value obtained by subtracting the width W of the mobile object from the minimum width D is equal to or greater than the second threshold.

In S23, the ECU 10 uses the side mirror control unit 13 to execute the rapid retraction of the side mirror on the side that the mobile object has entered. The side mirror control unit 13 rapidly retracts the side mirror by transmitting a control signal to the side mirror actuator 4. Thereafter, the ECU 10 ends the rapid side mirror retraction control.

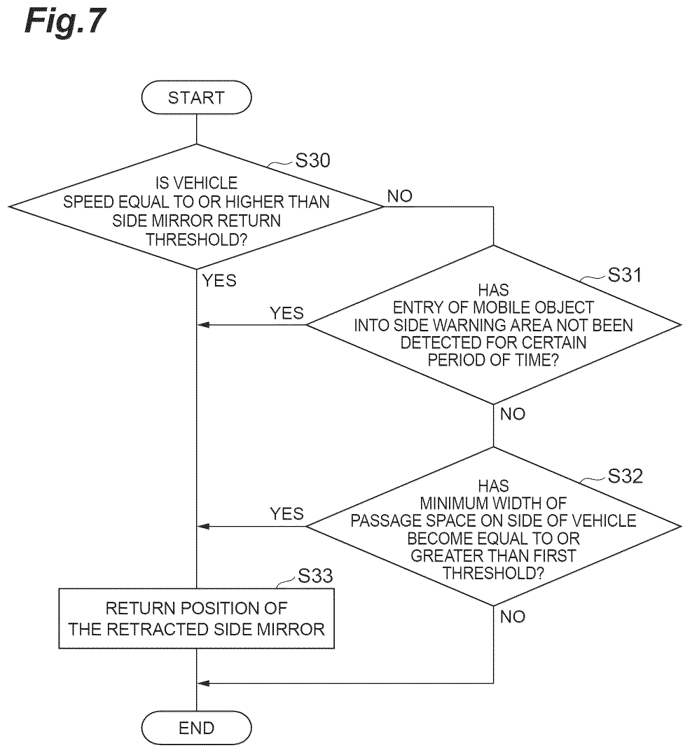

FIG. 7 is a flowchart illustrating an example of side mirror return control. The side mirror return control illustrated in FIG. 7 is performed on the side mirror retracted when the rapid side mirror retraction control illustrated in FIG. 5 is executed. That is, it is assumed that the minimum width D on the side that the mobile object has entered in the passage space on the side of the vehicle is smaller than the first threshold.

As illustrated in FIG. 7, in S30, the ECU 10 of the side mirror control device 100 uses the vehicle speed determination unit 12 to determine whether the vehicle speed of the vehicle 30 is lower than the side mirror return threshold. When the ECU 10 determines that the vehicle speed is lower than the side mirror return threshold (S30: YES), the ECU 10 proceeds to S33. When the ECU 10 does not determine that the vehicle speed is lower than the side mirror return threshold (S30: NO), the ECU 10 proceeds to S31.

In S31, the ECU 10 uses the side mirror control unit 13 to determine whether the entry of the mobile object into the side warning area 90 on the side in which the side mirror has been retracted has not been detected for a certain period of time. When the ECU 10 determines that the entry of the mobile object has not been detected for a certain period of time (S31: YES), the ECU 10 proceeds to S33. When the ECU 10 does not determine that the entry of a mobile object has not been detected for the certain period of time (S31: NO), the ECU 10 proceeds to S32.

In S32, the ECU 10 uses the side mirror control unit 13 to determine whether the minimum width D of the passage space on the side of the vehicle has become equal to or greater than the first threshold. For example, when the parked vehicle 61 in FIG. 4 moves, the minimum width D of the passage space changes. When the ECU 10 determines that the minimum width D is equal to or greater than the first threshold (S32: YES), the ECU 10 proceeds to S33. When the ECU 10 does not determine that the minimum width D is equal to or greater than the first threshold (S32: NO), the ECU 10 ends the side mirror return control. Thereafter, the ECU 10 repeats the processing from S30 again after a certain period of time.

In S33, the ECU 10 uses the side mirror control unit 13 to return the side mirror from the retracted state. The side mirror control unit 13 transmits a control signal to the side mirror actuator 4 to return the side mirror from the retracted state. Thereafter, the ECU 10 ends the side mirror return control.

According to the side mirror control device 100 (and the control method for the side mirror control device 100) according to the embodiment described above, since the side mirror on the side corresponding to the side warning area 90 is rapidly retracted when the entry of the mobile object into the side warning area 90 is detected in the side warning area 90 set on the left and right sides of the vehicle 30, it is possible to curb contact of a mobile object such as a bicycle or motorcycle that enters the side warning area 90 with the side mirror.

Further, according to the side mirror control device 100, when the minimum width D of the passage space on the side of the vehicle is equal to or greater than the first threshold, it is easy for the mobile object to avoid contact with the side mirror of the vehicle 30 by passing so the mobile object moves away from the vehicle 30, making it possible to avoid the retraction of the side mirror that is less required, without having to perform the retraction of the side mirror. Similarly, in the side mirror control device 100, when the value obtained by subtracting the width W of the mobile object from the minimum width D of the passage space on the side of the vehicle is equal to or greater than the second threshold, it is easy for the mobile object to avoid contact with the side mirror of the vehicle 30 by passing so the mobile object moves away from the vehicle 30, making it possible to avoid the retraction of the side mirror that is less required, as retraction is not performed.

Further, according to the side mirror control device 100, since the side mirror of the vehicle 30 is automatically returned from the retracted state when the entry of the mobile object into the side warning area 90 is not detected for the certain period of time, it is possible to improve convenience for the driver as compared to a case in which the side mirror is manually returned.

Further, according to the side mirror control device 100, since the side mirror of the vehicle 30 is automatically returned from the retracted state when the side mirror is retracted due to the minimum width D smaller than the first threshold, and then, the minimum width D of the passage space on the side of the vehicle becomes equal to or greater than the first threshold due to an environmental change such as movement of the parked vehicle 61 on the side of the vehicle, it is possible to improve convenience for the driver as compared to a case in which the side mirror is manually returned.

Although the embodiments of the present disclosure have been described above, the present disclosure is not limited to the above-described embodiments. The present disclosure can be implemented in various forms including the above-described embodiments, with various changes and improvements based on the knowledge of those skilled in the art.

For example, the side warning area 90 is not limited to the content described above. The side warning area 90 may have any area shape as long as the entry of a mobile object such as a bicycle passing near the side of the vehicle can be appropriately detected. The side warning area may be a rectangular area in plan view. The side warning area 90 may be set to extend rearward from the side mirror of the vehicle 30. In this case, the side warning area 90 does not include an area in front of the side mirror.

When the radar sensor 1 or the camera 2 detects a step structure of a road edge such as a curb, an area width of the side warning area 90 may be adjusted so as not to exceed the step structure of the road edge. The side warning area 90 may be set to exclude a space lower than the side mirror in a three-dimensional space. Alternatively, the mobile object detection unit 11 may not detect the entry of the mobile object into the side warning area 90 when a height of the mobile object is lower than the side mirror of the vehicle 30 even when the mobile object enters the side warning area 90.

In the flowchart illustrated in FIG. 5, order of S10, S11, and S12 is not limited. Vehicle speed determination processing in S11 may be performed first, and minimum width determination processing in S12 may be performed first. For example, the ECU 10 may be configured to start the detection of the entry of the mobile object into the side warning area 90 when the ECU 10 determines that the vehicle speed is lower than the side mirror retraction threshold. The ECU 10 may be configured to start detection of the entry of the mobile object into the side warning area 90 when the minimum width D of the passage space on the side of the vehicle is smaller than the first threshold. The same applies to the order of S10, S11, and S12 in FIG. 6.

In the rapid side mirror retraction control illustrated in FIG. 5, the ECU 10 does not necessarily need to perform the determination in S12. The ECU 10 may be configured to execute the rapid retraction of the side mirror when the detection of the mobile object in S10 and the determination of the vehicle speed in S11 are YES.

Further, the ECU 10 may be configured to perform the processing of S22 in FIG. 6 in the rapid side mirror retraction control illustrated in FIG. 5. That is, the ECU 10 may be configured not to perform the retraction of the side mirror when the value obtained by subtracting the width W of the mobile object from the minimum width D of the passage space that the mobile object enters is equal to or greater than the second threshold in the rapid side mirror retraction control illustrated in FIG. 5.

In the side mirror return control illustrated in FIG. 7, the ECU 10 does not necessarily need to perform the determination processing in S31 and S32. In addition to S30, the ECU 10 may be configured to execute only one of the processes of S31 and S32, or may be configured to execute neither S31 nor S32.

In addition, when the ECU 10 determines that the side mirror is retracted, and then, the entry of the mobile object into the side warning area 90 on the side in which the side mirror has been retracted is not detected for a certain period of time, the ECU 10 may be configured to continue counting for the certain period of time when a value obtained by subtracting the width W of the mobile object from the minimum width D of the passage space is equal to or greater than the second threshold even when the mobile object enters the side warning area 90.

What is claimed is:

1. A side mirror control device for controlling side mirrors of a vehicle, the side mirror control device comprising:
a mobile object detection unit configured to detect entry of a mobile object into a side warning area set on left and right sides of the vehicle; and
a side mirror control unit configured to rapidly retract the side mirror on the side corresponding to the side warning area when the entry of the mobile object into the side warning area is detected when a vehicle speed of the vehicle is lower than a side mirror retraction threshold.

2. The side mirror control device according to claim 1, wherein the side mirror control unit does not perform the retraction of the side mirror when a minimum width of a passage space on the side of the vehicle corresponding to the side warning area is equal to or greater than a first threshold even when entry of the mobile object into the side warning area is detected.

3. The side mirror control device according to claim 1, wherein the side mirror control unit does not perform the retraction of the side mirror when a value obtained by subtracting a width of the mobile object from a minimum width of a passage space on the side of the vehicle corresponding to the side warning area is equal to or greater than a second threshold even when entry of the mobile object into the side warning area is detected.

4. The side mirror control device according to claim 1, wherein the side mirror control unit returns the side mirror of the vehicle from a retracted state when the side mirror is retracted due to detection of the entry of the mobile object into the side warning area, and then, the entry of the mobile object into the side warning area is not detected for a certain period of time.

5. The side mirror control device according to claim 2, wherein the side mirror control unit returns the side mirror of the vehicle from a retracted state when the side mirror is retracted due to detection of the entry of the mobile object into the side warning area, and then, the entry of the mobile object into the side warning area is not detected for a certain period of time.

6. The side mirror control device according to claim 2, wherein the side mirror control unit returns the side mirror of the vehicle from a retracted state when the side mirror is retracted due to detection of the entry of the mobile object into the side warning area, and then, the minimum width of the passage space on the side of the vehicle corresponding to the side warning area is equal to or greater than the first threshold due to a change in an environment on the side of the vehicle.

7. A control method for a side mirror control device for controlling side mirrors of a vehicle, the control method for a side mirror control device comprising:
detecting entry of a mobile object into a side warning area set on left and right sides of the vehicle; and
rapidly retracting the side mirror on the side corresponding to the side warning area when the entry of the mobile object into the side warning area is detected when a vehicle speed of the vehicle is lower than a side mirror retraction threshold.
